(19) United States
(12) Patent Application Publication
(10) Pub. No.: US 2010/0103456 A1
(43) Pub. Date: Apr. 29, 2010

(54) Apparatus and system of image processing apparatus, and medium storing image processing control program

(75) Inventor: Masaya Masuda, Kawasaki-shi (JP)

Correspondence Address: HARNESS, DICKEY & PIERCE, P.L.C., P.O. BOX 8910, RESTON, VA, 20195, US

(73) Assignee: Ricoh Company, Ltd.

(21) Appl. No.: 12/588,604

(22) Filed: Oct. 21, 2009

(30) Foreign Application Priority Data
Oct. 23, 2008 (JP) 2008-273537

(51) Int. Cl. G06F 15/00

(52) U.S. Cl. 358/1.15

(57) ABSTRACT

An apparatus, system, and a method of image processing, and a recording medium including an image processing control program are disclosed. The system allows a user to select one or more image processing condition items, and stores the user selection as item setting information. Based on the item setting information, the system displays an instruction screen which displays an image processing condition specified by the one or more image processing condition items selected by the user.

### CROSS-REFERENCE TO RELATED APPLICATIONS

This patent application is based on and claims priority under 35 U.S.C. §119 to Japanese Patent Application No. 2008-273537, filed on Oct. 23, 2008, in the Japanese Patent Office, the disclosure of which is hereby incorporated herein by reference.

### FIELD OF THE INVENTION

The present invention generally relates to an image processing apparatus, an image processing system, an image processing method, and a recording medium storing instructions to perform the image processing method.

### BACKGROUND

The recent image processing apparatus is provided with many functions including the function of scanning, the function of fax transmission, the function of copying, the function of printing, etc. As a large number of functions are available for use, it has been cumbersome for the user to instruct such image processing apparatus to perform the operation desired by the user.

To simplify the process of inputting the user instruction, an instruction may be previously registered in the image processing apparatus as work flow data, which specifies one or more functions to be performed by the image processing apparatus, for example, as described in the US Patent Application Publication No. 2008/0068638, published on Mar. 20, 2008.

While the use of work flow data may help the user to simplify the process of inputting the user instruction, the user may be still requested to input detailed information. For example, when an original is to be scanned by the image processing apparatus, the user needs to confirm various settings such as the reading condition in which the original is to be read, the data format to be generated, etc. The user usually inputs various parameters through an operation panel provided on the image processing apparatus. Since a display section of the operation panel is limited in space, the user usually moves between the screens to input various parameters. Further, since the display section of the operation panel is designed for the general user, it may be cumbersome for the user who wants to change the setting relating to the parameter that is not commonly used by the general user.

### SUMMARY

In view of the above, there is a need for an image processing apparatus, system, or method, each of which allows a user to easily confirm the various settings that are currently set without requiring the user to change a screen currently displayed to the user. Further, there is a need for an image processing apparatus, system, or method, each of which allows a user to easily confirm the various settings that are currently set while only displaying information that is desired by the user.

Example embodiments of the present invention include an image processing system including an image processing apparatus to generate image data from an original according to a user instruction for starting image processing operation, and an information processing apparatus to manage the image processing apparatus through a network. The information processing apparatus includes: a user interface to allow a user to select one or more image processing condition items from a plurality of image processing condition items available to the image processing apparatus; and a communication interface to send item setting information specifying the one or more image processing condition items selected by the user to the image processing apparatus through the network. The image processing apparatus includes: a communication interface to receive the item setting information from the information processing apparatus; a storage device to store the item setting information obtained from the information processing apparatus through the communication interface, the one or more image processing condition items having corresponding one or more parameter values that together specify the image processing operation of the image processing apparatus; an operation controller to generate image processing condition information according to the item setting information, wherein the image processing condition information includes the one or more parameter values respectively corresponding to the one or more image processing condition items that are selected by the user; and an operation device to display an instruction screen. The instruction screen includes a section allowing the user to input the user instruction for starting image processing operation and a section displaying the one or more parameter values respectively corresponding to the one or more image processing condition items that are selected by the user. Alternatively or additionally, the storage device storing the item setting information may be provided in the information processing apparatus.

Example embodiments of the present invention include an image processing apparatus including: a controller to cause the image processing apparatus to generate image data from an original according to a user instruction for starting image processing operation; a storage device to store item setting information specifying one or more image processing condition items previously selected by a user from a plurality of image processing condition items available to the image processing apparatus, the one or more image processing condition items having corresponding one or more parameter values that together specify the image processing operation of the image processing apparatus; an operation controller to generate image processing condition information according to the item setting information, wherein the image processing condition information includes the one or more parameter values respectively corresponding to the one or more image processing condition items previously selected by the user; and an operation device to display an instruction screen. The instruction screen includes a section allowing the user to input the user instruction for starting image processing operation and a section displaying the one or more parameter values respectively corresponding to the one or more image processing condition items previously selected by the user.

Example embodiments of the present invention include a method of managing an image processing apparatus, including: allowing a user to select one or more image processing condition items from a plurality of image processing condition items available to the image processing apparatus; and storing item setting information specifying the one or more image processing condition items selected by the user, the one or more image processing condition items having corresponding one or more parameter values that together specify image processing operation of the image processing apparatus. The item setting information is used to generate image processing condition information, which includes the one or more parameter values respectively corresponding to the one or more image processing condition items that are selected by the user and to be displayed on an instruction screen. The instruction screen includes a section allowing the user to input a user instruction for starting the image processing operation and a section displaying the one or more parameter values respectively corresponding to the one or more image processing condition items selected by the user.

Example embodiments of the present invention include a recording medium storing a plurality of instructions which, when activated, cause a computer to perform the method of managing an image processing apparatus.

In addition to the above-described example embodiments, the present invention may be practiced in various other ways.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a schematic block diagram illustrating a configuration of an image processing system, according to an example embodiment of the present invention;

FIG. 2 is a block diagram illustrating a hardware structure of an information processing apparatus provided in the image processing system of FIG. 1;

FIG. 3 is a block diagram illustrating a functional structure of the information processing apparatus of FIG. 2 when it functions as an administrator terminal provided in the image processing system of FIG. 1;

FIG. 4 is a block diagram illustrating a functional structure of a management tool of the administrator terminal of FIG. 2;

FIG. 5 is an illustration for explaining the examples of information regarding a plurality of items stored in the management tool of FIG. 4;

FIG. 6 is a block diagram illustrating a functional structure of an image processing apparatus provided in the image processing system of FIG. 1;

FIG. 7 is a block diagram illustrating a functional structure of an operation controller of the image processing apparatus of FIG. 6;

FIG. 8 is a flowchart illustrating operation of scanning and storing, performed by the image processing apparatus of FIG. 6;

FIG. 9 is an illustration for explaining a geographical user interface, displayed by the image processing apparatus of FIG. 6;

FIG. 10 is an illustration for explaining a geographical user interface, displayed by the image processing apparatus of FIG. 6;

FIG. 11 is an illustration for explaining a geographical user interface, displayed by the image processing apparatus of FIG. 6;

FIG. 12 is an illustration for explaining a geographical user interface, displayed by the image processing apparatus of FIG. 6;

FIG. 13 is a data sequence diagram illustrating operation of managing the image processing apparatus of FIG. 6, performed by the image processing system of FIG. 1;

FIG. 14 is an illustration for explaining a geographical user interface, displayed by a management tool of the administrator terminal provided in the image processing system of FIG. 1;

FIG. 15 is an illustration for explaining information stored in a file server provided in the image processing system of FIG. 1;

FIG. 16 is a schematic block diagram illustrating a configuration of an image processing system, according to an example embodiment of the present invention; and

FIG. 17 is a data sequence diagram illustrating operation of managing the image processing apparatus of FIG. 6, performed by the image processing system of FIG. 16.

The accompanying drawings are intended to depict example embodiments of the present invention and should not be interpreted to limit the scope thereof. The accompanying drawings are not to be considered as drawn to scale unless explicitly noted.

### DETAILED DESCRIPTION OF EXAMPLE EMBODIMENTS

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments shown in the drawings, specific terminology is employed for the sake of clarity. However, the present disclosure is not intended to be limited to the specific terminology so selected and it is to be understood that each specific element includes all technical equivalents that operate in a similar manner.

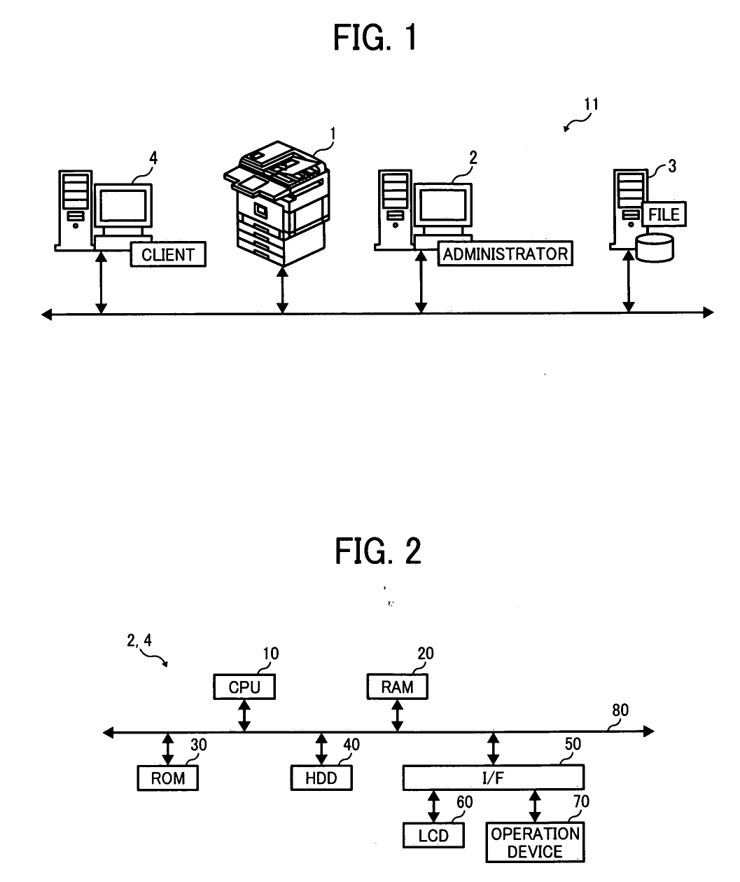

Referring now to FIG. 1, a configuration of an image processing system 11 is explained according to an example embodiment of the present invention. As illustrated in FIG. 1, the image processing system 11 includes an image processing apparatus 1, an administrator terminal 2, a file server 3, and a client terminal 4.

The image processing apparatus 1 includes a plurality of functions including an image capturing function, an image forming function, and a communication function, etc. Using one or more of the plurality of functions, the image processing apparatus 1 operates as a multifunctional apparatus capable of functioning as a printer, facsimile, scanner, copier, etc. In this example, the administrator terminal 2 is an information processing apparatus operated by an administrator who manages the image processing apparatus 1. In this example, the file server 3 is a storage device, which stores various data such as image data or document data obtained by the image processing apparatus 1 using the scanning function, for example. The client terminal 4 is an information processing apparatus operated by a user who uses one or more of the plurality of functions of the image processing system 11.

The image processing apparatus 1, the administrator terminal 2, the file server 3, and the client terminal 4 are connected through a network. As illustrated in FIG. 1, in this example, the image processing apparatus 1 and the administrator terminal 2 are each provided independently from each other. Alternatively, the image processing apparatus 1 and the administrator terminal 2 may be provided as one apparatus.

Referring to FIG. 2, a hardware structure of the information processing apparatus, which may function as the administrator terminal 2 or the client terminal 4, is explained according to an example embodiment of the present invention. In this example, the information processing apparatus is implemented by a general-purpose computer. Referring to FIG. 2, the information processing apparatus includes a central processing unit (CPU) 10, a random access memory (RAM) 20, a read only memory (ROM) 30, a hard disk drive (HDD) 40, and an interface (I/F) 50, which are connected through a bus 80. To the I/F 50, a display device 60 such as a liquid crystal display (LCD) and an operation device 70 such as a mouse and/or a keyboard are connected.

The CPU 10, which has a function of computing, controls entire operation of the information processing apparatus. The RAM 20 is a volatile memory, which allows high-speed reading or writing of data therefrom or thereto. The RAM 20 may function as a work area of the CPU 10 when the CPU 10 processes various data. The ROM 30 is a non-volatile read only memory, and stores various programs such as firmware program. The HDD 40 is a readable/writable non-volatile memory, and stores various programs including the Operating System (OS), various control programs, and various application programs.

The I/F 50 connects the bus 80 with various hardware devices or the network, or controls the connections. The display device 60, which may be referred to as the LCD 60, is a user interface, which allows the user to obtain information regarding the status of the information processing apparatus. The operation device 70 is a user interface, such as the keyboard or the mouse, which allows the user to input various information.

The file server 3 of FIG. 1 may have a hardware structure substantially similar to the hardware structure illustrated in FIG. 2, except that the user interface such as the LCD 60 and the operation device 70 does not have to be provided. The image processing apparatus 1 may have a hardware structure substantially similar to the hardware structure illustrated in FIG. 2, except that additional devices to perform image forming operations such as scanning or printing are provided including, for example, an image forming engine.

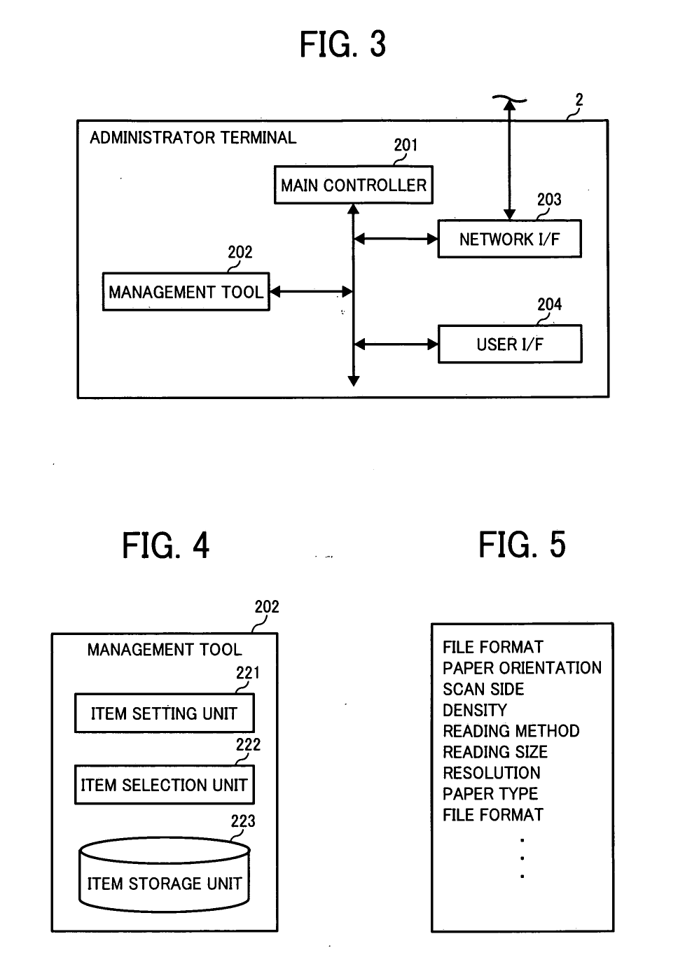

In this example, the information processing apparatus of FIG. 2 is caused to operate as the administrator terminal 2 of FIG. 1 according to an image processing control program. More specifically, when the image processing control program, which may be stored in any desired memory such as the ROM 30, the HDD 40, or any other recording medium such as an optical disc, is loaded onto the RAM 20, the CPU 10 creates a software control section, such as a functional block of FIG. 3, that controls the hardware structure of FIG. 2 according to the loaded image processing control program.

Referring to FIG. 3, the functional block of the administrator terminal 2 is explained. As illustrated in FIG. 3, the administrator terminal 2 includes a main controller 201, a management tool 202, a network I/F 203, and a user I/F 204.

The main controller 201 controls entire operation of the administrator terminal 2. The management tool 202 is implemented by an application, which provides the administrator terminal 2 with a function of managing the image processing apparatus 1. The network I/F 203 is an interface, which allows communication between the administrator terminal 2 and the other apparatus such as the image processing apparatus 1. For example, the network I/F 203 may be implemented by any network in compliance with, for example, the Ethernet or USB.

The user I/F 204 is an interface, which allows the user to operate the administrator terminal 2 or allows the user to obtain various information regarding the status of the administrator terminal 2. The functions of the user I/F 204 may be performed by the mouse or the keyboard functioning as the operation device 70, and/or the display device 60. The main controller 201 may be implemented by the software control section, which is created when the image processing control program is loaded onto the RAM 20 and operates under control of the CPU 10, and the hardware section such as an integrated circuit of the information processing apparatus of FIG. 2. The function of the management tool 202 may be performed by the application software that is loaded onto the RAM 20 and operates under control of the CPU 10.

Referring to FIG. 4, a functional structure of the management tool 202 is explained according to an example embodiment of the present invention. As illustrated in FIG. 4, the management tool 202 includes an item setting unit 221, an item selection unit 222, and an item storage unit 223. The item setting unit 221 sends information, such as item setting information, to the image processing apparatus 1 according to a user instruction received through the network I/F 203.

The item selection unit 222 allows the user to select one or more items, such as the reading condition item, to be included in a screen for display to the user which allows the user to instruct the image processing apparatus 1 to perform a work flow operation. The item storage unit 223 stores information regarding one or more items that can be selected by the user through the item selection unit 122. FIG. 5 lists the examples of the items that are stored in the item storage unit 223.

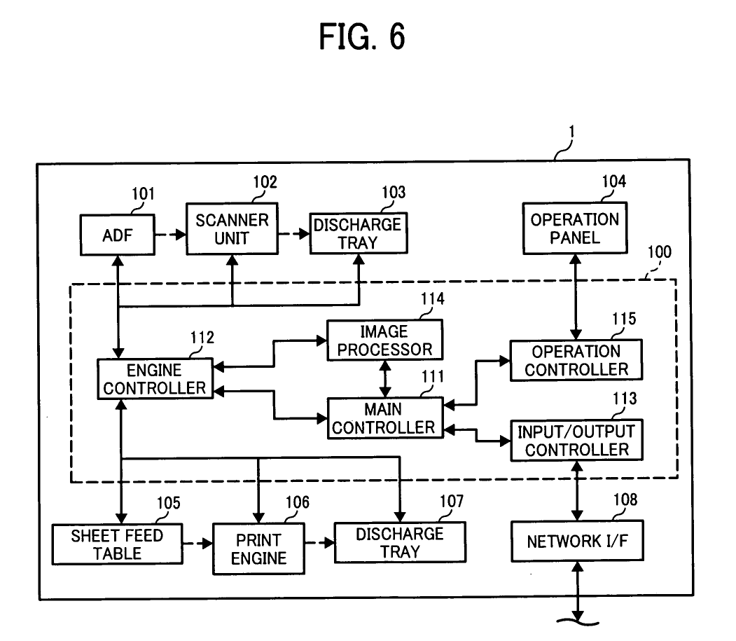

Referring now to FIG. 6, a structure of the image processing apparatus 1 is explained according to an example embodiment of the present invention. As illustrated in FIG. 6, the image processing apparatus 1 mainly includes a controller 100, an automatic document feeder (ADF) 101, a scanner unit 102, a discharge tray 103, an operation panel 104, a sheet feed table 105, a print engine 106, a discharge tray 107, and a network I/F 108.

The controller 100 includes a main controller 111, an engine controller 112, an input/output controller 113, an image processor 114, and an operation controller 115. As illustrated in FIG. 6, the image processing apparatus 1 is implemented as a multifunctional apparatus provided with the scanner unit 102 and the print engine 106. In FIG. 6, the electrical connections are shown as the solid arrows, while the flow of the recording sheet to be processed by the image processing apparatus 1 is shown as the dashed arrows.

The operation panel 104 functions as an output interface, which displays information regarding the status of the image processing apparatus 1. The operation panel 104 further functions as an input interface, such as an operation device, which allows the user to input various information to the image processing apparatus 1 through various keys or buttons, for example. In this example, the operation panel 104 may be implemented by a touch panel screen functioning as the output interface and the input interface. The network I/F 108 is an interface, which allows the image processing apparatus 1 to communicate with the other apparatus such as the administrator terminal 2 through the network. The network I/F 108 may be implemented by any desired interface, which may be in compliance with the Ethernet or the USB, for example.

The controller 100 may be implemented by the software structure and the hardware structure, which cooperatively operate. More specifically, the controller 100 may include a CPU and any desired memory such as a ROM, RAM, or HDD. The image processing control program such as firmware may be loaded from any desired memory such as the ROM or the HDD onto the RAM to create a software control section according to the image processing control program that is loaded. The controller 100 performs operation using the hardware structure such as the integrated circuit according to the instructions obtained by the software control section. In this example, the controller 100 functions as a controller that controls entire operation of the image processing apparatus 1.

The main controller 111 has a function of controlling one or more of the sections provided in the controller 100, for example, by sending an instruction to one or more of the sections in the controller 100. The engine controller 112 may function as a driving device, which controls or drives the print engine 106 or the scanner unit 102. The input/output controller 113 inputs a signal or an instruction, which is received through the network I/F 108, to the main controller 111. Alternatively, the input/output controller 113 outputs a signal or an instruction through the network OF 108 from the main controller 111. The main controller 111 controls operation of the input/output controller 113. The main controller 111 may further control the access to the other apparatus through the network I/F 108 and the network.

The image processor 114 generates drawing data based on image data to be printed under control of the main controller 111. The image data to be printed is any information, which may be referred by the print engine 106 functioning as an image forming section to form an image on an image carrier. The image processor 114 may process image data captured and input by the scanner unit 102. The image data that has been input may be stored in a memory of the image processing apparatus 1 as scanned data. Alternatively, the image data may be sent to the file server 3 through the network I/F 108. The operation controller 115 may cause the operation panel 104 to display various information or notify the main controller 111 regarding various information input through the operation panel 104.

When the image processing apparatus 1 functions as a printer, the input/output controller 113 receives a printing job through the network I/F 108 from the outside apparatus such as the client terminal 4. The input/output controller 113 transfers the printing job that is received to the main controller 111. The main controller 111 causes the image processor 114 to generate drawing data according to information such as document information or image information obtained from the printing job. The engine controller 112 causes the print engine 106 to form an image on a recording sheet that is transferred from the sheet feed table 105 according to the drawing data. For example, the print engine 106 may form an image according to the ink jet printing method or the electrophotographic method. Depending on the printing method, the print engine 106 may have any desired image forming mechanism. The recording sheet having the image printed thereon may be output onto the discharge tray 107.

When the image processing apparatus 1 functions as a scanner, the user inputs a user instruction for scanning, through the operation panel 104 or the client terminal 4 connected to the network through the network I/F 108. When the user instruction is received, the operation controller 115 or the input/output controller 113 transfers a signal for instructing scanning operation to the main controller 111. The main controller 111 controls the engine controller 112 according to the signal for instructing scanning operation. The engine controller 112 drives the ADF 101 to transfer an original to be scanned, which may be set to the ADF 101, to the scanner unit 102. The engine controller 112 drives the scanner unit 102 to read the original that is transferred from the ADF 101 into image data. Alternatively, when the original is provided onto an exposure glass of the scanner unit 102, the scanner unit 102 reads the original into image data under control of the scanner controller 112. In this example, the scanner unit 102 functions as an image capturing section.

More specifically, the scanner unit 102 includes an imaging sensor such as a charged coupled device (CCD), which generates the image data by converting the optical image data obtained by scanning the original to the electric image data. The engine controller 112 transfers the image data generated by the scanner unit 102 to the image processor 114. The image processor 114 generates processed image data according to the image data received through the engine controller 112 under control of the main controller 111. The processed image data that is generated by the image processor 114 may be stored in a memory such as the HDD of the image processing apparatus 1. The processed image data generated by the image processor 114 may be kept stored in the HDD, or may be further sent to the outside apparatus such as the file server 3 through the input/output controller 113 and the network I/F 108 according to a user instruction.

When the image processing apparatus 1 functions as a copier, the image processor 114 may generate the drawing data based on the image data received from the scanner unit 102 or the processed image data stored in the memory. The engine controller 112 causes the print engine 106 to form an image on a recording sheet according to the drawing data.

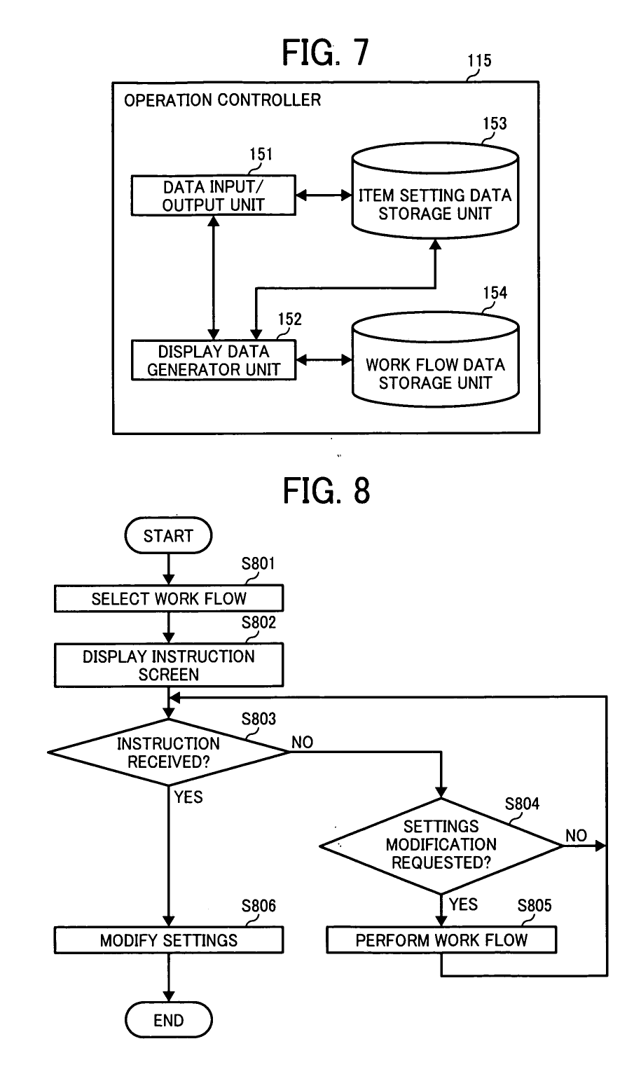

Referring to FIG. 7, a functional structure of the operation controller 115 is explained according to an example embodiment: of the present invention. As illustrated in FIG. 7, the operation controller 115 includes a data input/output unit 151, a display data generator unit 152, an item setting data storage unit 153, and a work flow data storage unit 154.

The data input/output unit 151 processes the input or output of data between the operation panel 104 or the main controller 111, and the operation controller 115. The display data generator unit 152 generates information to be included in a screen to be displayed by the operation panel 104. The item setting data storage unit 152 and the work flow data storage unit 154 each store information relating to the screen to be displayed by the operation panel 104 when the work flow is to be operated.

Referring to FIG. 8, operation Of scanning an original into document data and storing the document data in the file server 3, performed by the image processing apparatus 1, is explained according to an example embodiment of the present invention. In this example, it is assumed that the user operates the image processing apparatus 1 through the operation panel 104 to instruct operation of scanning an original into document data and storing the document data.

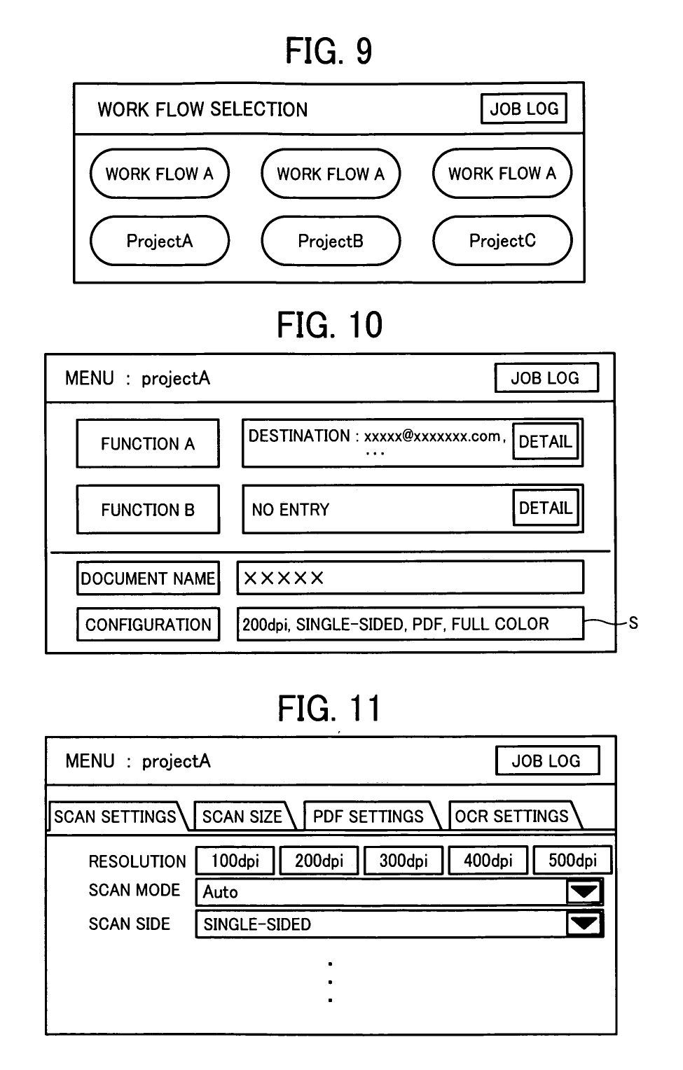

Further, it is assumed that the operation of scanning an original into document data and storing the document data in the file server 3 is previously stored as the work flow data. The work flow data specifies one or more functions to be performed by the image processing apparatus 1 as well as various information indicating how such functions are performed. For example, the one or more functions may be selected from any one or any combination of the scanning function, facsimile function, printing function, copying function, data transfer function, etc. In this particular example, the work flow data specifies the scanning function and the data transfer function. Further, in this example, the various information may include information regarding the destination to which the document data is sent for storage, the reading condition at which the original is read, etc. Accordingly, in order to instruct the image processing apparatus 1 to perform operation of scanning the original into the document data and storing the document data in the file server 3, at S801, the user selects the specific work flow. FIG. 9 illustrates an example graphical user interface, such as a screen, which is displayed on the operation panel 104 to allow the user to select the work flow at S801.

Referring to FIG. 9, the operation panel 104 displays, on its screen, one or more work flow buttons according to information regarding one or more work flows that is stored in the work flow data storage unit 154. In this example, the work flow data storage unit 154 stores the information regarding one or more work flows to be performed by the image processing apparatus 1, such as the name identifying the work flow, various operations or functions to be performed by the work flow, and various data to be used when performing the various operations or functions for the work flow. The various data to be used when performing the various operation for the work flow may include, for example, information regarding the reading condition at which the original is read by scanning, and/or information regarding the destination address to which the image data obtained by scanning is stored. The display data generator unit 153 generates information to be displayed on a screen, such as the screen of FIG. 9, according to the information obtained from the work flow data storage unit 154.

The user may select the work flow to be performed, for example, by touching one of the work flow buttons provided by the screen of FIG. 9. When one of the work flow buttons is selected by the user, the data input/output unit 151 of the operation controller 115 obtains information regarding the selected one of the work flow buttons through the operation panel 104, from the work flow data storage unit 154. The display data generator unit 152 generates information to be included in an instruction screen for allowing the user to instruct the work flow operation using the information obtained by the data input/output unit 151, and causes the operation panel 104 to display such information on the instruction screen displayed to the user at S802. For example, the instruction screen of FIG. 10 may be displayed to the user, which includes various information generated by the display data generator unit 152 according to information regarding the work flow “Project A” that is selected from the screen of FIG. 9.

The instruction screen of FIG. 10 displays thereon the function A button and the function B button, each of which allows the user to instruct the image processing apparatus 1 to perform the selected work flow operation. The instruction screen of FIG. 10 further displays thereon the “Document Name” button, and the document name display section that is provided at the side of the “Document Name” button. The instruction screen of FIG. 10 further displays thereon the “Configuration” button, and the reading condition display section S which displays information regarding the image reading condition, side by side. In this example, information such as “200 dpi, single-sided, PDF, full-color” is displayed by the reading condition display section S. Since information regarding the image reading condition is displayed on the instruction screen together with the other buttons including the button to instruct performing of the work flow operation, the user can instantly recognize the image reading condition that has been set at the time of instructing the image processing apparatus 1 to perform the selected work flow operation. With this function, the user does not have to request the image processing apparatus 1 to display one or more other screens to display the image reading condition, of change between the screens to confirm the image reading condition that has been set.

In this example, one or more items to be displayed on the reading condition display section S are determined based on the item setting data that is stored in the item setting data storage unit 153. The item setting data storage unit 153 stores information regarding one or more items to be displayed on the reading condition display section S of the instruction screen, which may be referred to as the setting item information. The setting item information is previously selected by the user, for example, through the management tool 202 of the administrator terminal 2 as described below. Further, in this example, in addition to the setting item information, the item setting data storage unit 153 stores information regarding the order in which the items identified by the setting item information are displayed on the screen. The display data generator unit 152 determines the order in which the items are displayed on the reading condition display section S according to the order for displaying the items, which is stored in the item setting data storage unit 153.

Referring back to FIG. 10, when the user selects the “Function A” button or the “Function B” button, the image processing apparatus 1 recognizes that the user instruction for performing the corresponding work flow operation is input. At the side of each of the “Function A” and the “Function B” buttons, information regarding the destination to which the image data is transferred for storage is displayed. In this particular example, such destination information has not previously stored for the “Function B”.

Referring back to FIG. 8, at S803, when the user instructs to perform the selected work flow operation through the instruction screen (“YES” at S803), the data input/output unit 151 of the operation controller 115 notifies the main controller 111 to start performing the selected work flow operation. More specifically, the data input/output unit 151 provides the main controller 111 with information regarding the work flow selected at S801, which is obtained from the work flow data storage unit 154. At 5806, the image processing apparatus 1 performs the work flow operation according to the setting information that has been previously registered, and the operation ends. At S806, the engine controller 112 controls operation of the ADF 101 and/or the scanner unit 102 under control of the main controller 111.

At S803, when the user instruction for performing the selected work flow is not received (“NO” at S803), the operation proceeds to S804 to determine whether a user instruction for modifying the settings is received. At 5804, when the user instruction for modifying the settings, such as modifying the image reading condition, is received (“YES” at S804), the operation proceeds to S805. When the user instruction for modifying the settings is not received (“NO” at S804), the operation returns to S803.

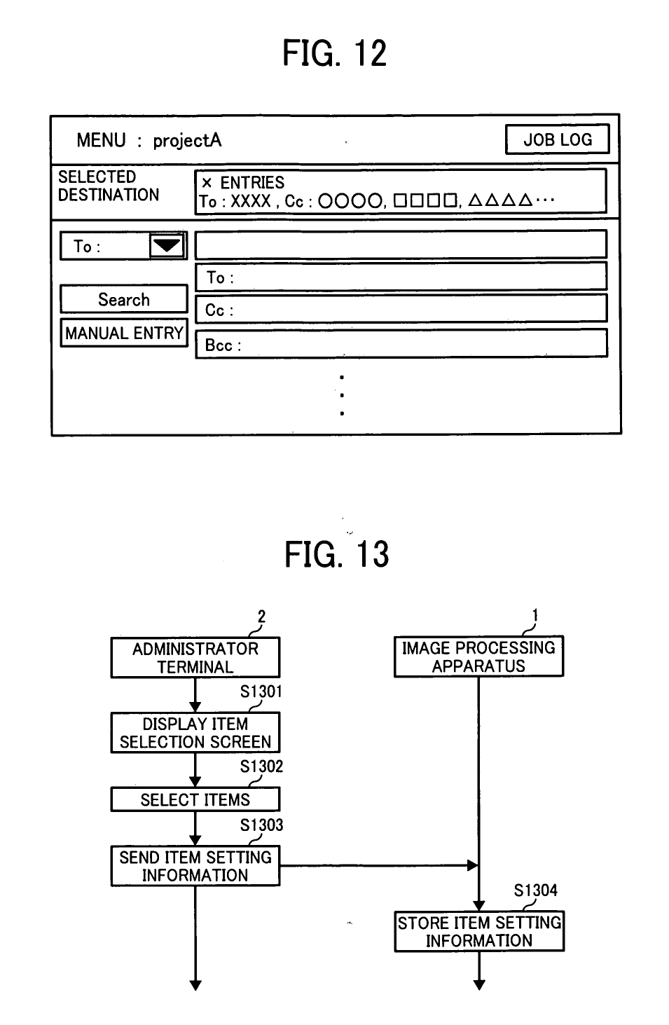

Referring to FIG. 10, when the user selects the “Configuration” button, before selecting the “Function A” button or the “Function B” button, the operation controller 115 of the image processing apparatus 1 may display a setting screen that allows the user to set the image reading condition as illustrated in FIG. 11 under control of the main controller 111. When the user selects the “Detail” button on the screen of FIG. 10, before selecting the “Function A” button or the “Function B” button, the image processing apparatus 1 may display a setting screen that allows the user to set the destination as illustrated in FIG. 12.

FIG. 11 illustrates an example setting screen, which allows the user to set the image reading condition. The screen of FIG. 11 includes a plurality of setting tabs including the scan settings tab, scan size tab, PDF settings tab, and OCR settings tab. When one of the setting tabs is selected, an input section that allows the user to input the detailed settings is displayed for the selected setting tab. In this example, the reading condition may correspond to a plurality of operation parameters that may be used to determine the operation of the scanner unit 102 in reading the original into image data, or the operation of the image processor 114 in generating the processed image data from the image data obtained by the scanner unit 102. Referring to FIG. 11, the scan settings tab allows the user to input information regarding the resolution, the scan mode, the side to be scanned, etc.

FIG. 12 illustrates an example setting screen, which allows the user to set the destination. The screen of FIG. 12 displays thereon information regarding the destination that may be previously set as the “Selected Destination” section. In addition, the screen of FIG. 12 displays thereon the “To” field, “Cc” field, and “Bcc” field, each of which may allow the user to input specific information. The screen of FIG. 12 further displays the “Search” button and the “Manual Entry” button.

At S805 of FIG. 8, the user may input various information to set the image reading condition or the destination through the screen of FIG. 11 or 12. The information input by the user at S805 may be stored in the data input/output unit 151. When requesting the main controller 111 to perform the work flow operation, the data input/output unit 151 may send information that has been input by the user to the main controller 111 or notify the main controller 111 of such information. Through the data input/output unit 151, the user may set various settings. When the settings are completed, the operation returns to S803 to determine whether the user instruction for performing the work flow operation is received.

As described above referring to FIG. 10, the reading condition information to be displayed on the reading condition display section S of FIG. 10 may be previously set or modified at any desired time by the management tool 202 of the administrator terminal 2 according to the user preference. This improves the user operability as the user can instantly view the desired information at the top screen.

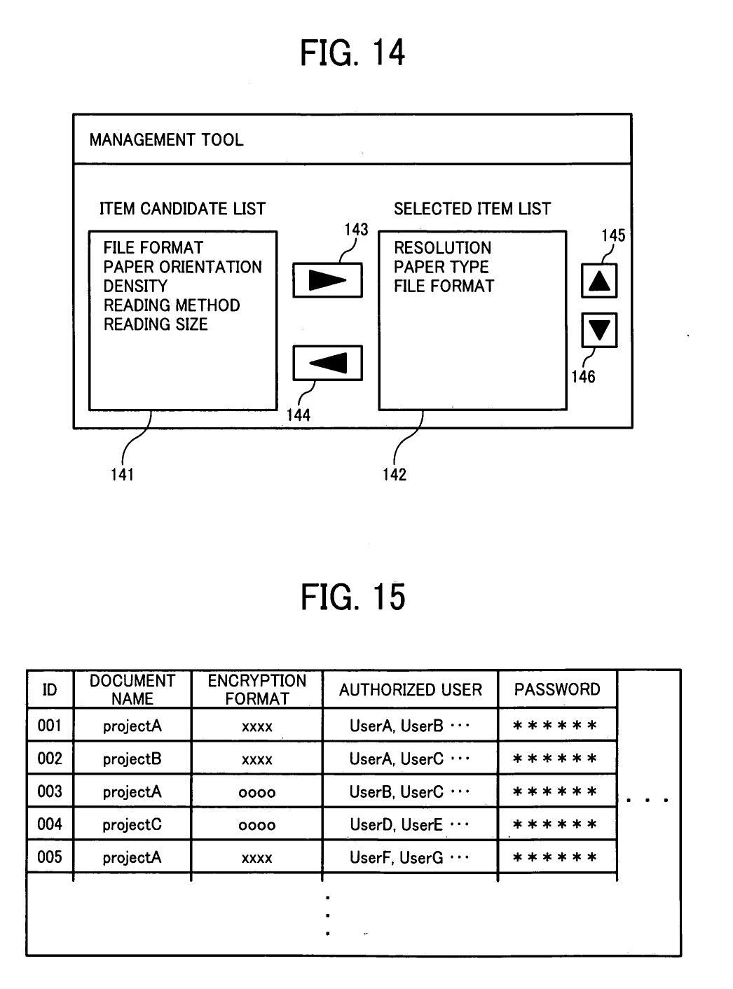

Referring to FIG. 13, operation of managing the image processing apparatus 1, performed by the management tool 202, is explained according to an example embodiment of the present invention. At S1301, the management tool 202 of the administrator terminal 2 displays a screen on the user I/F 204, which allows the user to set one or more items to be included in the instruction screen. FIG. 14 illustrates an example item selection screen to be displayed at S1301, which allows the user to select one or more items to be included in the instruction screen. Referring to FIG. 14, the item selection screen includes an item candidate list 141, a selected item list 142, a selection key 143, a selection cancel key 144, an up key 145, and a down key 146. The item selection screen of FIG. 14 may be displayed on the user I/F 204 by the item selection unit 222 of the management tool 202.

The item candidate list 141 displays a list of a plurality of items stored in the item storage unit 223 as the candidate for selection by the user, which may be displayed on the reading condition display section S of the instruction screen when selected. The selected item list 142 displays a list of one or more items that have been selected by the user to be displayed on the reading condition display section S of the instruction screen. The selection key 142 allows the user to select one or more of the plurality of items that are displayed on the item candidate list 141. When the selection key 142 is pressed while the item on the item candidate list 141 is highlighted, the highlighted item is moved to the selected item list 142. The selection cancel key 143 allows the user to cancel the selection of one or more of the plurality of items that are displayed on the selected item list 142. When the selection cancel key 144 is pressed while the item on the selected item list 142 is highlighted, the highlighted item is moved back to the item candidate list 141 from the selected item list 142.

The one or more items that are displayed on the selected item list 142 are originally displayed in the order that have been selected. The user may use the up key 145 or the down key 146 to change the order in which the items are displayed on the selected item list 142. According to the order in which the items are displayed on the selected item list 142, the items are displayed on the reading condition display section S of the instruction screen. When the up key 145 is pressed while the item on the selected item list 142 is highlighted, the highlighted item moves up by one order. When the down key 146 is pressed while the item on the selected item list 142 is highlighted, the highlighted item moves down by one order.

Through the item selection screen of FIG. 14, the user inputs various information regarding the items, as well as their display orders, to be displayed on the reading condition display section S, to the administrator terminal 2. The information regarding the items to be displayed on the reading condition display section S as well as their display order may be collectively referred to as the item setting information.

The management tool 202 obtains the item setting information input by the user through the user I/F 204. At S1302 of FIG. 13, the item selection unit 222 selects one or more items to be displayed on the reading condition display section S of the instruction screen from the item storage unit 223 according to the user instruction input through the user I/F 204 by the user. At S1303, the item selection unit 222 sends information regarding the items selected at S1302 to the item setting unit 221 together with information regarding the orders of displaying the selected items. The item setting unit 221 sends the information regarding the selected items as well as their display orders, which may be referred to as the item setting information, to the image processing apparatus 1 through the network I/F 203. As described above, in this example, the item setting information includes information regarding the items to be displayed on the reading condition display section S and the order of which each item is displayed.

When the item setting information is received from the administrator terminal 2, the main controller 111 obtains the item setting information through the input/output control unit 113, and inputs such information to the operation controller 115. At S1304, the operation controller 115 obtains and stores the item setting information in the item setting data storage unit 153. In this manner, the item setting information, which is managed by the operation controller 115, may be modified according to the user preference. When the image processing apparatus 1 displays the instruction screen of FIG. 10 on the operation panel 104, the display data generator unit 152 generates information to be included in the reading condition display section S according to the modified item setting information.

In the above-described image processing system 11, the image processing apparatus 1 displays the reading condition information on the instruction screen for instructing the image processing apparatus 1 to perform the work flow operation. Further, the reading condition information may be modified by the user through the management tool 202. This improves the user operability as only the information desired by the user is displayed on the top screen.

Since the image processing apparatus 1 provides the plurality of functions, the operation panel 104 is not able to provide all kinds of information on one screen such that the user usually needs to move between screens to set various parameters for various items in order to complete one instruction. Depending on the item that is needed by the user, information regarding the needed item may be designed to be displayed far below the top screen. In such case, it may take time for the user to reach the screen including the information regarding the needed item. With the above-described function of displaying the detailed information regarding various parameters that have been set on the top screen, the user is made free from such cumbersome operation.

Further, the user is allowed to modify one or more items to be displayed on the top screen at any desired time according to the user preference. Since the instruction screen to be displayed to the user can be customized for each user, the user operability of the image processing apparatus 1 increases.

More specifically, the management tool 202 includes the item setting unit 221 and the item selection unit 222. The item selection unit 222 allows the user to select one or more items, each of which may be set as the image reading condition that determines the operation of reading the original into image data, according to the user preference. The item setting unit 221 causes the operation controller 115 to store information regarding the one or more items that are selected by the user through the item selection unit 222.

In this example, the management tool 202 may be implemented as software, which may be operated on any desired management apparatus, such as the administrator terminal 2, for managing the image processing apparatus 1 that is capable of reading an original into image data. The management tool 202 includes the item selection unit 222 that selects one or more items, which may be set as a reading condition that determines the operation of reading the original into the image data performed by the image processing apparatus 1. The management tool 202 further includes the item storage unit 223 that stores information regarding one or more items to be selected by the user through the item selection unit 222. The item setting information, which may be selected by the item selection unit 222 from the item storage unit 223 according to the user instruction, may be obtained and stored in the item setting unit 221, for example, as the item setting information. Alternatively, the item setting information maybe stored in any desired device such as the item storage unit 223. The item setting information may be referred by the display data generator unit 152 of the image processing apparatus 1, which generates information to be included in a screen that is displayed to the user to allow the user to instruct the operation of reading. More specifically, the item setting data storage unit 152 stores the item setting information, which is obtained through the data ‘input/output unit 151 from the management tool 202. The display data generator unit 152 causes the screen to include the reading condition information that is set according to the one or more selected items specified by the item setting information obtained from the item setting data storage unit 153.

For example, once the display data generator unit 152 obtains the item setting information specifying the one or more items that are selected by the user and their display orders, the display data generator unit 152 specifies the item to be displayed first, and further obtains the parameter value that is set for the item to be displayed first. The display data generator unit 152 causes the obtained parameter value to be displayed first in the reading condition display section S. In a substantially similar manner, the display data generator unit 152 specifies the item to be displayed second, and further obtains the parameter value that is set for the item to be displayed second. The display data generator unit 152 causes the obtained parameter value to be displayed second, following the firstly displayed parameter, in the reading condition display section S. This operation is repeated until there is no item to be displayed.

Further, in this example, the item setting information may be generated in the form of XML data file. In such case, the items that are selected by the user and their parameter values may be written as property data.

Further, the data input/output unit 151 allows the user to modify various settings including the reading condition to be used for the scanning operation and the destination to be used for the data transferring operation. The data input/output unit 151 may cause the item setting information, which is stored in the item setting data storage unit 153, to be modified according to the user instruction. The display data generator unit 152 obtains the item setting information, which may be modified, from the item setting data storage unit 153, and generates information to be included in the instruction screen for allowing the user to instruct the work flow operation so as to include the one or more items specified by the item selection information that may be modified.

In the above-described examples, the item selection unit 222 causes the item candidate list 141 to display the plurality of items that is stored in the item storage unit 223. Alternatively, information to be displayed on the screen of FIG. 5 may be stored in the operation controller 115 of the image processing apparatus 1. In such case, the item selection unit 222 obtains the information to be displayed from the operation controller 115 of the image processing apparatus 1, and generates the information to be displayed on the item setting screen of FIG. 14. In such case, the item setting unit 221 of the management tool 202 may be replaced with a communication unit that communicates with the operation controller 115. Alternatively, the item setting unit 221 of the management tool 202 may not be provided as the function of the communication unit for communicating with the operation controller 115 may be performed by the item setting item 221.

In the above-described examples, the operation controller 115 includes the item setting data storage unit 153, which stores information regarding the one ore more items that are selected by the user for display. Alternatively, the management tool 202 may additionally include the item setting data storage unit 153. In such case, when performing the operation of FIG. 8, the image processing apparatus 1 obtains the item setting information from the administrator terminal 2, and displays the instruction screen of FIG. 10.

In the above-described examples, the user operates the image processing apparatus 1 directly through the operation panel 104 to perform the work flow operation. Alternatively, the user may instruct the image processing apparatus 1 to perform the work flow operation according to application software installed on the client terminal 4. In such case, the screens illustrated in FIGS. 9 to 12 may be displayed on the LCD 60 of the client terminal 4 according to the application software installed on the client terminal 4. In this manner, the above-described functions performed by the operation controller 115 may be alternatively performed by the application software installed on the client terminal 4.

The items that are stored in the item storage unit 223 are not limited to the examples described above referring to FIG. 5. For example, the user may select any item, which is not most likely to be selected by the other user, according to the user preference. In this manner, the user is able to visually check the configuration related to the item specifically selected by the user through the operation panel 104. For example, the image processing apparatus 1 may identify a user who is currently logged onto the system of the image processing apparatus 1. Once the user is identified, the image processing apparatus 1 may communicate with the administrator terminal 2, or any other terminal, that is assumed to be assigned to the user that is currently logged onto the system of the image processing apparatus 1 to obtain the item setting information previously set by the user. Based on the item setting information that is obtained, the operation controller 115 of the image processing apparatus 1 may determine information to be included in the instruction screen to be displayed on the operation panel 104. With this function, the image processing apparatus 1 can always provide the instruction screen, which has been customarily generated for the user who is currently logged on. The instruction screen may include any desired information, which may not be otherwise displayed on the operation panel 104, as long as the user has previously set the item setting information using, for example, the management tool 202.

In such case, the image processing apparatus 1 may store the item setting information for each of the users that are registered into the system of the image processing apparatus 1.

In the above-described examples, the one or more items that can be set through the management tool 202 are the information to be displayed on the reading condition display section S of the instruction screen of FIG. 10. The management tool 202 may additionally manage various other information. For example, as illustrated in FIG. 12, the management tool 202 may manage information regarding the destination to which the data is sent for storage so as to cause the screen to display one or more items regarding the destination according to the user preference. More specifically, in alternative to displaying all the “To” field, “Cc” field, and “Bcc” field, only the “To” field, or only the “To” and “Cc” fields may be displayed.

Further, after performing the operation of FIG. 8, the management tool 202 may set additional information that may be stored together with the data to be stored in the file server 3.

FIG. 15 illustrates example data stored in the file server 3. As illustrated in FIG. 15, the file server 3 stores, for each data that is stored in the file server 3, document ID, document name, encryption format, authorized user, and password. The management tool 202 may allow the user to set any of the information stored in the file server 3 so as to be displayed on the instruction screen.

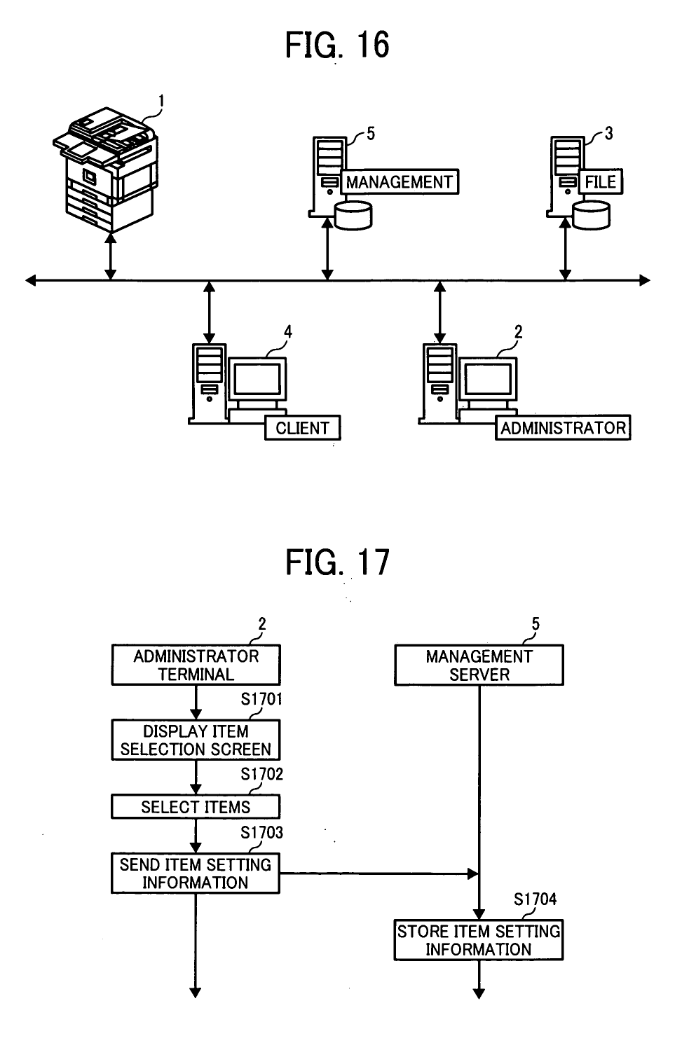

In the above-described examples, the administrator terminal 2 is caused to directly manage the image processing apparatus 1 through the network. Alternatively, the administrator terminal 2 may cause to manage the image processing apparatus 1 though a server, such as a management server to manage the image processing apparatus 1. For example, as illustrated in FIG. 16, the image processing apparatus 11 of FIG. 1 may be additionally provided with a management server 5 connected to the network.

In this example, the management server 5 may have a hardware structure that is substantially similar to the hardware structure of FIG. 2, with the exception that none of the LCD 60 and the operation device 70 has to be provided. The management server 5 may function as the item setting storage unit 153 of the operation controller 115 described above referring to FIG. 7. In order to modify or customize the items to be displayed on the reading condition display section S of the instruction screen, the management terminal 2 updates the item setting information stored in the management server 5, for example, as described below referring to FIG. 17.

FIG. 17 illustrates a data sequence diagram illustrating operation of managing the image processing apparatus 1, performed by the image processing system of FIG. 16, according to an example embodiment of the present invention. S1701 and S1702 are respectively performed in a substantially similar manner as described above referring to S1301 and S1302 of FIG. 13. At S1703, the administrator terminal 2 sends the setting item information specifying the one or more items that are selected by the user to the management server 5. At S1704, the management server 5 stores the setting item information obtained from the administrator terminal 2 in its memory.

When performing the operation of FIG. 8 by the image processing system of FIG. 16, the image processing apparatus 1 obtains the item setting information from the management server 5, and displays the instruction screen of FIG. 10 that includes information generated according to the item setting information.

By managing the image processing apparatus 1 through the management server 5, only one administrator terminal 2 may be needed to manage more than one image processing apparatus 1. In such case, the management server 5 may store item setting information for each one of the image processing apparatuses 1. Further, in this example, the number of the management server 5 is not limited to one as illustrated in FIG. 16 such that more than one management server 5 may be provided over the network. Further, the management server 5 may store the item setting information specifically set for each user, for each one of the plurality of users that are registered to the image processing apparatus 1.

Any one of the above-described image processing systems, apparatuses, and methods may be implemented in various other ways.

For example, the image data obtained by the image processing apparatus 1 through scanning may be sent to the destination apparatus either directly from the image processing apparatus 1 to the destination apparatus through the network, or indirectly from the image processing apparatus 1 to the destination apparatus via any other apparatus such as the administrator terminal 2, for example.

Further, any one of the apparatuses provided on the image processing system may be provided with the management tool 202 of FIG. 4, which allows the user to determine one or more items to be displayed and their display orders.

Further, the image data may be sent in any desired format such as the image data attached to the body of the email message.

Numerous additional modifications and variations are possible in light of the above teachings. It is therefore to be understood that within the scope of the appended claims, the disclosure of the present invention may be practiced otherwise than as specifically described herein.

With some embodiments of the present invention having thus been described, it will be obvious that the same may be varied in many ways. Such variations are not to be regarded as a departure from the spirit and scope of the present invention, and all such modifications are intended to be included within the scope of the present invention.

For example, elements and/or features of different illustrative embodiments may be combined with each other and/or substituted for each other within the scope of this disclosure and appended claims.

Further, as described above, any one of the above-described and other methods of the present invention may be embodied in the form of a computer program stored in any kind of storage medium. Examples of storage mediums include, but are not limited to, flexible disk, hard disk, optical discs, magneto-optical discs, magnetic tapes, involatile memory cards, ROM (read-only-memory), etc.

Alternatively, any one of the above-described and other methods of the present invention may be implemented by ASIC, prepared by interconnecting an appropriate network of conventional component circuits or by a combination thereof with one or more conventional general purpose microprocessors and/or signal processors programmed accordingly.

In one example, the present invention may reside in an image processing apparatus for reading an original and generating image data from the original. The image processing apparatus includes a condition setting unit to set a plurality of items each specifying a reading condition in which the original is read; an item setting information obtain unit to obtain item setting information specifying one or more items that are selected by the user from the plurality of items; and a display data generator unit to generate information to be included in an instruction screen according to the item setting information, wherein the instruction screen allows the user to instruct operation of reading and includes the reading conditions respectively specified by the one or more items that are selected by the user. The item setting information includes display order information indicating the order in which the one or more items that are selected by the user are displayed on the instruction screen. The display data generator unit generates the information to be displayed such that the reading conditions respectively specified by the one or more items that are selected by the user are displayed according to the display order information.

In the above-described image processing apparatus, the condition setting unit sets an operation parameter of a reading unit that reads the original as the reading condition.

In the above-described image processing apparatus, the condition setting unit sets an operation parameter of an image data generator unit that generates the image data as the reading condition.

In the above-described image processing apparatus, the condition setting unit sets an image data format of the image data generated from the original that is read as the reading condition.

In the above-described image processing apparatus, the condition setting unit sets information regarding the destination to which the image data is transferred as the reading condition.

The image processing apparatus further includes an item data storage unit to store the item setting information. The item setting information obtain unit obtains the item setting information from the item data storage unit.

In one example, the present invention reside in an image processing system including an image processing apparatus configured to read an original and generate image data from the original and a management apparatus configured to manage the image processing apparatus. The image processing apparatus includes a condition setting unit to set a plurality of items each specifying a reading condition in which the original is read; and a display data generator unit to generate information to be included in an instruction screen, which allows the user to instruction operation of reading and includes the reading conditions respectively specified by the one or more items that are selected by the user. The management apparatus includes an item selection unit to select the one or more items each specifying the reading condition; and an item data storage unit to store information regarding the one or more items that are selected by the user as item setting information to be referred by the image processing apparatus. The display data generator unit generates the information to be included in the instruction screen such that the reading conditions respectively specified by the one or more items that are selected is displayed in the instruction screen.

In the above-described image processing system, the item selection unit further allows the user to determine display order information specifying the order in which the one or more items that are selected by the user are displayed on the instruction screen. The display data generator unit generates the information to be displayed such that the reading condition respectively specified by the one or more items that are selected by the user are displayed according to the display order information.

In the above-described image processing system, the condition setting unit sets an operation parameter of a reading unit that reads the original as the reading condition.

In the above-described image processing system, the condition setting unit sets an operation parameter of an image data generator unit that generates the image data as the reading condition.

In the above-described image processing system, the condition setting unit sets an image data format of the image data generated from the original that is read as the reading condition.

In the above-described image processing system, the condition setting unit sets information regarding the destination to which the image data is transferred as the reading condition.

In one example, the present invention may reside in a recording medium storing the instructions to cause an information processing apparatus to operate as a management apparatus to manage an image processing apparatus by performing the steps including: allowing a user to select one or more items each specifying a reading condition in which an original is read by the image processing apparatus; and storing item setting information regarding the one or more items that are selected by the user. The item setting information is referred by a display data generator unit to generate information to be included in an instruction screen, which allows the user to instruct operation of reading and includes the reading conditions respectively specified by the one or more items that are selected by the user.

In the above-described example, an operation parameter of a reading unit that reads the original may be set as the reading condition.

In the above-described example, an operation parameter of an image data generator unit that generates the image data may be set as the reading condition.

In the above-described example, an image data format of the image data generated from the original that is read may be set as the reading condition.

In the above-described example, information regarding the destination to which the image data is transferred may be set as the reading condition.

In one example, the present invention may reside in an information processing apparatus for managing an image processing apparatus, the information processing apparatus including: a storage device configured to store information regarding a plurality of image processing condition items available to the image processing apparatus; a user interface configured to allow a user to select one or more image processing condition items from the plurality of image processing condition items; and a communication interface configured to send item setting information specifying the one or more image processing condition items selected by the user to the image processing apparatus.

In any one of the above-described examples, the one or more parameter values for the one or more image processing conditions items include at least one of: information regarding the type of the original to be read, the orientation of the original to be read with respect to the image reading device, the size of the original to be read, the side of the original to be read, the image density of the image data, the reading method used by the image reading device, the resolution of the image data, the file format of the image data, etc.

What is claimed is:

1. An image processing system, comprising:
an image processing apparatus configured to generate image data from an original according to a user instruction for starting image processing operation; and
an information processing apparatus configured to manage the image processing apparatus through a network,
wherein the information processing apparatus includes:
a user interface configured to allow a user to select one or more image processing condition items from a plurality of image processing condition items available to the image processing apparatus;
a storage device configured to store item setting information specifying the one or more image processing condition items selected by the user, the one or more image processing condition items having corresponding one or more parameter values that together specify the image processing operation of the image processing apparatus;
a communication interface configured to send the item setting information to the image processing apparatus through the network, and
wherein the image processing apparatus includes:
a communication interface configured to obtain the item setting information from the information processing apparatus;
an operation controller configured to generate image processing condition information according to the item setting information, wherein the image processing condition information includes the one or more parameter values respectively corresponding to the one or more image processing condition items that are selected by the user; and
an operation device configured to display an instruction screen, wherein the instruction screen includes a section allowing the user to input the user instruction for starting image processing operation and a section displaying the one or more parameter values respectively corresponding to the one or more image processing condition items that are selected by the user.

2. The image processing system of claim 1, wherein the item setting information obtained respectively by the information processing apparatus and the image processing apparatus further includes display order information set by the user through the user interface, the display order information specifying the order in which the one or more image processing condition items are arranged, and
the operation controller of the image processing apparatus is further configured to generate the image processing condition information so as to cause the one or more parameter values to be displayed on the instruction screen according to the order specified by the display order information.

3. The image processing system of claim 2, wherein when the image processing apparatus is configured to further send the image data to an outside apparatus through the network using the communication interface according to the user instruction for starting image processing operation,
the instruction screen further displays one or more operation parameter values of the communication interface of the image processing apparatus as the one or more parameter values respectively corresponding to the one or more image processing condition items, the one or more operation parameter values of the communication interface including information regarding the outside apparatus to which the image data is to be sent.

4. An image processing apparatus, comprising:
a controller configured to cause the image processing apparatus to generate image data from an original according to a user instruction for starting image processing operation;
a storage device configured to store item setting information specifying one or more image processing condition items previously selected by a user from a plurality of image processing condition items available to the image processing apparatus, the one or more image processing condition items having corresponding one or more parameter values that together specify the image processing operation of the image processing apparatus;
an operation controller configured to generate image processing condition information according to the item setting information, wherein the image processing condition information includes the one or more parameter values respectively corresponding to the one or more image processing condition items previously selected by the user; and
an operation device configured to display an instruction screen, wherein the instruction screen includes a section allowing the user to input the user instruction for starting image processing operation and a section displaying the one or more parameter values respectively corresponding to the one or more image processing condition items previously selected by the user.

5. The image processing apparatus of claim 4, wherein the item setting information stored in the storage device further includes display order information previously set by the user, the display order information specifying the order in which the one or more image processing condition items are arranged, and
the operation controller is configured to generate the image processing condition information so as to cause the one or more parameter values to be displayed on the instruction screen according to the order specified by the display order information.

6. The image processing apparatus of claim 5, wherein when the operation device further receives, from the user, a modified parameter value of at least one of the one or more parameter values that are displayed on the instruction screen, the operation controller updates the image processing condition information using the modified parameter value so as to cause the operation device to display the one or more parameter values including the modified parameter value on the instruction screen.

7. The image processing apparatus of claim 6, further comprising:
an image reading device configured to read the original into scanned image data, wherein the instruction screen displays one or more operation parameter values of the image reading device as the one or more parameter values respectively corresponding to the one or more image processing condition items.

8. The image processing apparatus of claim 7, further comprising:
an image processing device configured to process the scanned image data to generate the image data, wherein the instruction screen displays one or more operation parameter values of the image processing device as the one or more parameter values respectively corresponding to the one or more image processing condition items, the one or more operation parameter values of the image processing device including information regarding a data format of the image data.

9. The image processing apparatus of claim 8, wherein when the controller causes the image processing apparatus to further send the image data to an outside apparatus through the network using the communication interface according to the user instruction for starting image processing operation,
the instruction screen further displays one or more operation parameter values of the communication interface as the one or more parameter values respectively corresponding to the one or more image processing condition items, the one or more operation parameter values of the communication interface including information regarding the outside apparatus to which the image data is to be sent.

10. The image processing apparatus of claim 9, further comprising:
a communication interface configured to obtain the item setting information from an information processing apparatus through a network, wherein the one or more image processing condition items and the order in which the one or more image processing condition items are arranged are respectively selected by the user through the information processing apparatus.

11. The image processing apparatus of claim 9, wherein:
the operation device is further configured to obtain, directly from the user, the item setting information specifying the one or more image processing condition items that are selected by the user and the order in which the one or more image processing condition items are arranged, and to store the item setting information in the storage device.

12. A recording medium storing a plurality of instructions which, when activated, cause a computer to perform a method of managing an image processing apparatus, the method comprising:
allowing a user to select one or more image processing condition items from a plurality of image processing condition items available to the image processing apparatus;
storing item setting information specifying the one or more image processing condition items selected by the user, the one or more image processing condition items having corresponding one or more parameter values that together specify image processing operation of the image processing apparatus, wherein:
the item setting information is used to generate image processing condition information, which includes the one or more parameter values respectively corresponding to the one or more image processing condition items that are selected by the user and to be displayed in an instruction screen, wherein the instruction screen includes a section allowing the user to input a user instruction for starting the image processing operation and a section displaying the one or more parameter values respectively corresponding to the one or more image processing condition items selected by the user.
